(19) United States
(12) Patent Application Publication
(10) Pub. No.: US 2020/0128768 A1
(43) Pub. Date: Apr. 30, 2020

(54) LIQUID-STORING PLANTING DEVICE

(71) Applicant: Chun-Hsien HO, New Taipei City (TW)

(72) Inventor: Chun-Hsien HO, New Taipei City (TW)

(21) Appl. No.: 16/176,561

(22) Filed: Oct. 31, 2018

(51) Int. Cl. A01G 27/04; A01G 27/00

(52) U.S. Cl. CPC A01G 27/04; A01G 9/028; A01G 27/005

(57) ABSTRACT

A liquid-storing planting device is disclosed. The liquid-storing planting device includes a first box and a second box. The first box includes a plurality of lateral walls and a plurality of first through holes formed on the lateral walls. A tubular body is inserted into the first through hole to connect and communicate two adjacent first boxes. A supporting member is mounted within the first box. A second box is tacked on the first box. A plurality of second through holes are formed on the second box. Each of the second through holes is provided with a liquid absorbing strip. The liquid absorbing strip hangs down to the inside of the first box through the second through hole. The liquid stored in the first box is transferred to the second box by capillary effect of the liquid absorbing strip so as to provide a friendly planting environment.

### BACKGROUND OF THE INVENTION

### Field of the Invention

The invention relates to a planting device, and more particularly to a planting device having structural expandability and functions of storing and saving water.

### Description of the Related Art

Due to rapid city development and large requirements, a large number of lands is used to build high-rise buildings so that the lands that can be used for planting plants is not easily found or available in the city, and it is also affected by the factors of urban cementation. Water resources are not easy to preserve, and this also brings about the consequences of urban desertification. Under this vicious circle, it also brings about the problem of urban heat island effect or global warming.

In view of this problem, in order to reduce the problem of urban heat island effect and make good use of the existing urban environment, the practice of planting trees on the top floor of high-rise buildings has become a new trend.

A conventional method often used is to directly install vessels for loading soil on the top floor of the high-rise building, and plants and even vegetables are planted in the vessels. In addition that the sunlight can be directly picked up by the plants, this can also reduce the area of the building exposed to sunlight and further reduce the thermal temperature of the building.

Although the conventional method considers both planting the plants and reducing the area exposing to the sun, the method using such vessels still needs a regular water source for irrigation. When no regular water source is available for the plants, no sufficient water can be supplied to the plants, and the plants are easy to withered and even die. Therefore, it is a problem to be solved by the person skillful in the art, how to provide a regular water source for irrigation without adding additional equipment.

### BRIEF SUMMARY OF THE INVENTION

An object of the invention is to provide a liquid-storing planting device suitable for various places. Preclaimed water can be filled into a water storing space in the liquid-storing planting device to provided water for the plants planted in the liquid-storing planting device directly so as to reduce water consumption. Water can be supplemented into the water storing space in the liquid-storing planting device when the water is insufficient therein. Therefore, the liquid-storing planting device of the invention provides a suitable environment for plant growth.

To achieve the described object of the invention, the invention provides a liquid-storing planting device. The liquid-storing planting device in accordance with an exemplary embodiment of the invention includes a first box configured to store liquid and including a plurality of lateral walls connected to each other to form a periphery, wherein each of the lateral wall includes an upper edge and a first through hole formed near the upper edge; a tubular body has one end inserted into one of the first through hole and the other end inerted into another first box adjacent to the first box to communicate the first boxes; furthermore, a supporting member is disposed within the first box, wherein the supporting member has a height identical to the first box to resist a pressure exerting downwards; the liquid-storing planting device of the invention further includes a second box stacked on the first box and including a second bottom and a plurality of second through holes formed on the bottom; a plurality of liquid absorbing strips extend into the first box through the second through hole, wherein each of the liquid absorbing strips including a positioning knot formed at one end of the liquid absorbing strip, wherein the liquid absorbing strips naturally hangs from the second bottom of the second box down to the first box due to the size of the positioning knot is larger than the dimension of the second through hole, the liquid absorbing strips absorb the liquid stored in the first box and transfer the liquid to the second box through capillary effect.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is an exploded view of an embodiment of the liquid-storing planting device of the invention;

FIG. 2 is an exploded view of an embodiment of the liquid-storing planting device of the invention;

FIG. 3 is a perspective view of the liquid-storing planting device of the invention;

FIG. 4 is a cross section of the liquid-storing planting device of FIG. 3;

FIG. 5 an exploded view of another embodiment of the liquid-storing planting device of the invention;

FIG. 6 is an exploded view of an embodiment of the liquid-storing planting device of the invention; and

FIG. 7 is a cross section of the liquid-storing planting device of FIG. 6.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

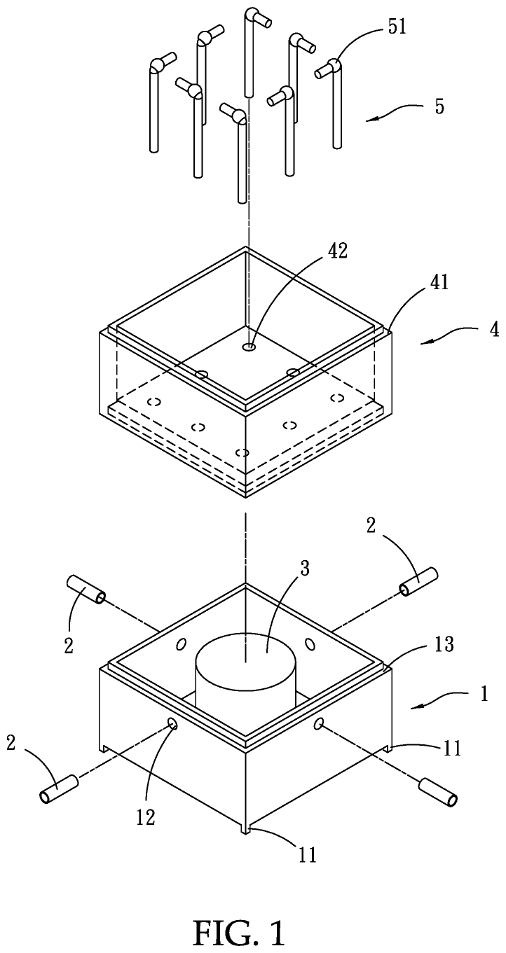

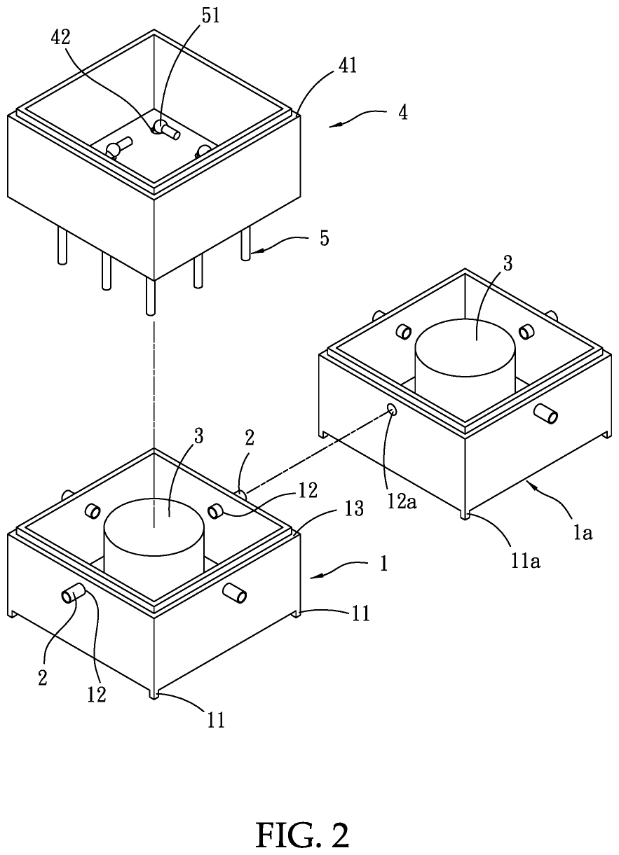

Referring to FIG. 1, a liquid-storing planting device of the invention includes a first box 1. In this embodiment, the first box 1 is utilized to store liquid. The liquid is exemplary a reclaimed water. The first box is rectangular. The first box 1 has four corners on a bottom thereof. Each of the corners is provided with a spacer extending downwards. In this embodiment, the spacer is integrally formed with the first box 1. The spacer separates the first box 1 from the ground where the first box 1 is placed. A gap is formed between the first box 1 and the ground to allow air flowing therethrough so as to maintain the bottom of the first box 1 dry. The first box 1 includes a plurality of lateral walls connected to each other to form a periphery of the first box 1. Each of the lateral walls has a first through hole 12 formed near an upper edge of the lateral wall. Each of the first through holes 12 is inserted by a tubular body 2. The tubular body 2 is exemplary a hose. One end of the tubular body 2 extends to inside of the first box 1 through the first through hole 12. As shown in FIG. 2, the other end of the tubular body 2 is inserted into another first box 1a adjacent to the first box 1 through a first through hole 12a formed on the first box 1a so that the tubular body 2 connects the first box 1 and the first box 1a, and therefore the first box 1 communicates with the first box 1a through the tubular body 2. An outer chamfer 13 is formed on the periphery of the first box 1. A supporting member 3 is mounted in the first box 1. In this embodiment, the supporting member 3 is a hollow cylinder. The supporting member 3 is exemplarily made of Styrofoam. The supporting member 3 has a height the same as the height of the first box 1 for resisting a pressure exerting downwards.

Referring to FIG. 1 again, the liquid-storing planting device of the invention includes a second box 4 stacked on the first box 1. The second box 4 and the first box 1 are rectangular and have identical dimensions. A second bottom of the second box 4 has an inner chamfer 41. The inner chamfer 41 engages the outer chamfer 13 when the second box 4 is stacked onto the first box 1 so that the second box 4 is position to the first box 1. A plurality of second through holes 42 are formed on the second bottom of the second box 4. Each of the second through holes 42 is provided with a liquid absorbing strip 5. A positioning knot 51 is formed at one end of the liquid absorbing strip 5. The positioning knot 51 is held on the second bottom of the second box 4 due to the size of the positioning knot 51 is larger than the dimension of the second through hole 42 so that the liquid absorbing strip 5 can naturally hang from the second box 2 to the inside of the first box 1 through the second through hole 42, as shown in FIG. 2.

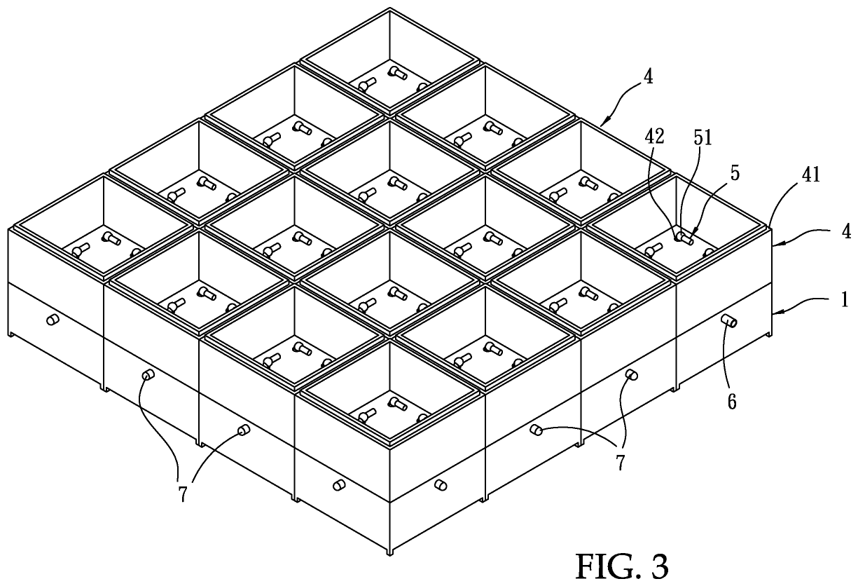

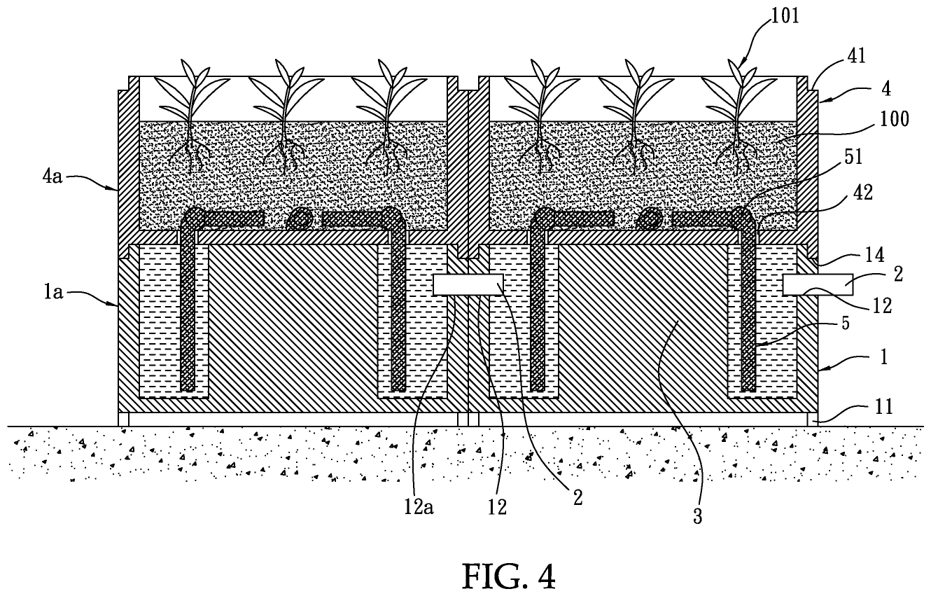

Referring to FIG. 3, the liquid-storing planting device of the invention is placed on a hard ground such as a top floor of a building. A plurality of the first boxes 1 are placed on the hard ground, and two adjacent first boxes 1 are connected to each other and thus communicate with each other by the tubular body 2. A connecting pipe 6 configured to connect to an external water source is connected to one of the first boxes 1 through the first through holes 12. In this embodiment, the first through holes 12 of the first boxes 1 provided with no tubular body 2 are sealed by a plug 7 inserted thereto. Water are filled into the first box 1 through the connecting pipe 6. When the first box 1 is full, the excess water flows to other adjacent first boxes 1 through the tubular bodies 2 connected to the periphery of the very first box 1. The first boxes 1 serve as an appliance for storing water. As shown in FIG. 4, each of the first boxes 1 is joined to a second box 4 atop. In addition that the first box 1 bears the weight of the second box 4, the supporting member 3 mounted within the first box 1 also bears a part of the weight of the second box 4 so that the weight of the second box 4 are evenly supported by the first box 1 and the supporting member 3. Soil 100 are loaded in the second box 4. The soil 100 covers the positioning knot 51 of the liquid absorbing strip 5, and plants 101 are planted into the soil 100. The liquid (water) stored in the first box 1 are transferred to the second box 4 by capillary effect of the liquid absorbing strips 5 mounted between the first box 1 and the second box 4. The liquid enters the soil 100 and can be absorbed by the plants 101, whereby a friendly environment for the plants 101 are constructed by the first box 1 and the second box 4, and the liquid-storing planting device of the invention is suitable for any hard ground environment.

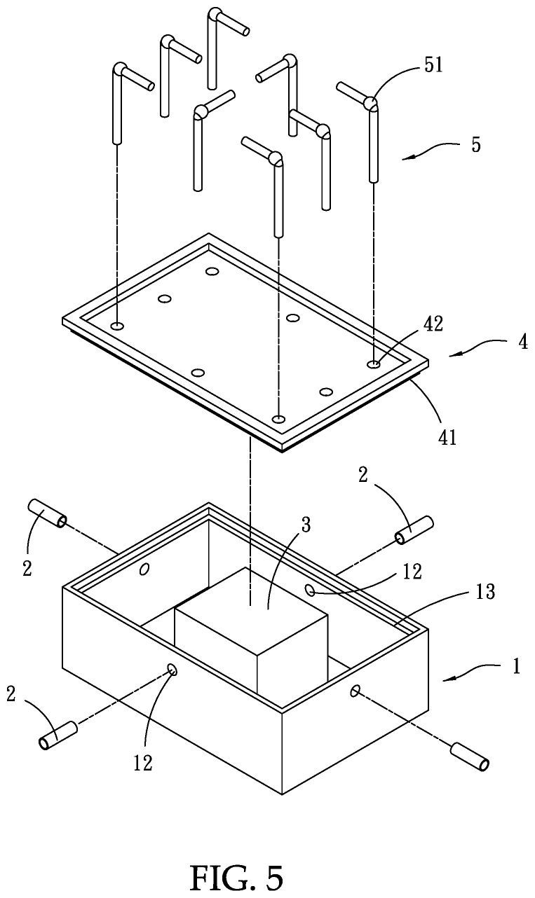

Referring to FIG. 5, another embodiment of the liquid-storing planting device of the invention is disclosed. The difference between this embodiment and the embodiment of FIG. 1 is that the height of the second box 4 is reduced to a minimal value (slightly larger than the second bottom), and the second box 4 is stacked on the first box 1. A plurality of second through holes 42 are formed on the second bottom. Each of the second through hole 42 is provided with a liquid absorbing strip 5. A positioning knot 51 is formed at one end of the liquid absorbing strip 5. The positioning knot 51 is held on the second bottom of the second box 4 due to the size of the positioning knot 51 is larger than the dimension of the second through hole 42 so that the liquid absorbing strips 5 naturally hang from the second box 4 down to the inside of the first box 1 through the second through hole 42. In addition, a supporting member 3 is mounted in the first box 1. In this embodiment, the supporting member 3 is a rectangular hollow body.

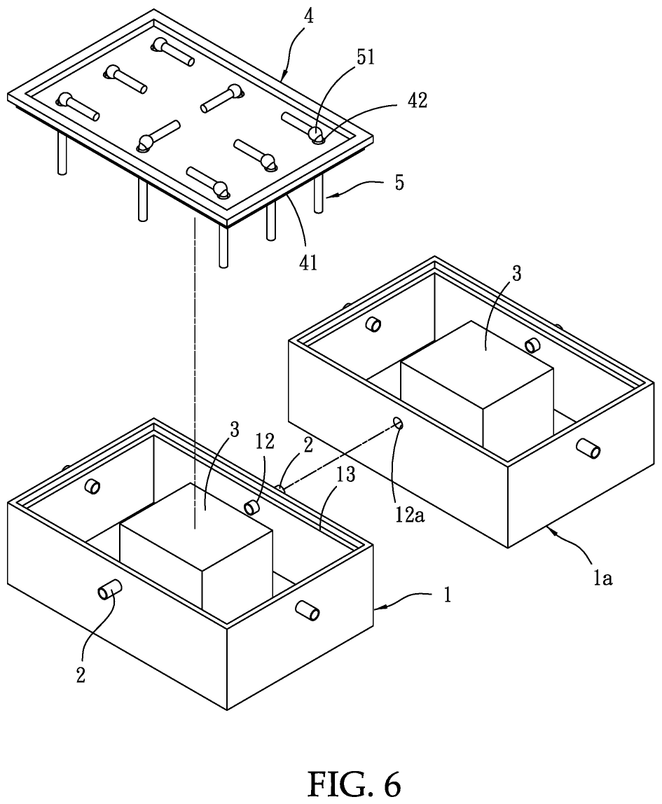

Referring to FIG. 6, two adjacent first boxes 1 are connected to each other and communicates with each other by the tubular body 2. Each first box 1 are stacked by the second box 4 so that the liquid absorbing strips 5 naturally hang from the second box 2 down to the inside of the first box 1.

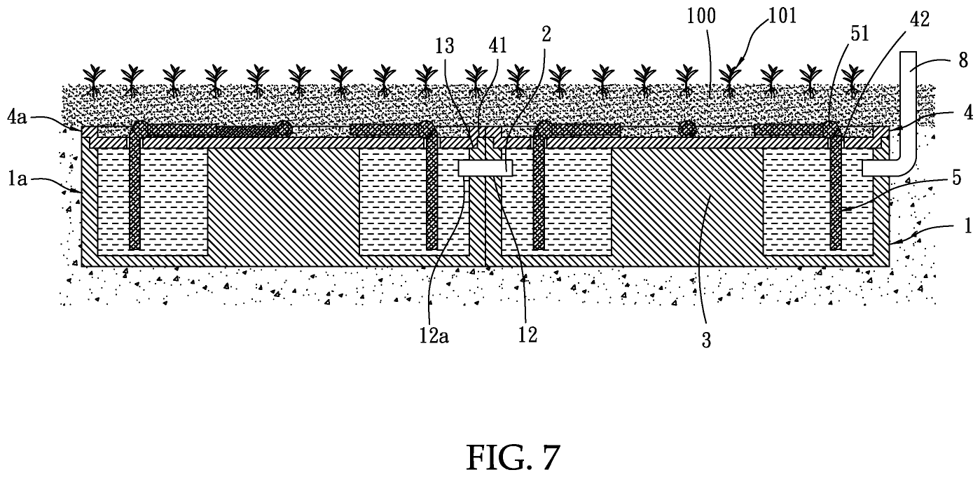

Referring to FIG. 7, the liquid-storing planting device of this embodiment is suitable for a back yard of a house. The first boxes 1 are put into a predigged recess on the ground, and the first boxes 1 are properly arranged in the recess. The adjacent first boxes 1 are connected to each other and communicated with each other by the tubular body 2. A conduit 8 configured to connect to an external water source, such as household water, is connected to the first box 1 through one of the first through holes 12. Water is filled into one of the first boxes 1 through the conduit 8. When the first box 1 is full, the excess water flows to other adjacent first boxes 1 through the tubular bodies 2 connected to the periphery of the very first box 1. The first boxes 1 serve as an appliance for storing water. Each of the first boxes 1 is joined to a second box 4 atop. In addition that the first box 1 bears the weight of the second box 4, the supporting member 3 mounted within the first box 1 also bears a part of the weight of the second box 4, whereby the weight of the second box 4 are thus evenly supported by the first box 1 and the supporting member 3. Soil 100 are loaded in the second box 4. The soil 100 covers the positioning knot 51 of the liquid absorbing strip 5, and plants 101 are planted into the soil 100. The liquid (water) stored in the first box 1 are transferred to the second box 4 by capillary effect of the liquid absorbing strips 5 mounted between the first box 1 and the second box 4. The liquid enters the soil 100 for absorption of the plants 101. The cleaner preclaimed water (household wastewater) produced by the family can be collected in the first boxes 1. The preclaimed water is utilized again for the plants 101 so as to save water consumption.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A liquid-storing planting device, comprising:
a first box configured to store liquid and comprising a plurality of lateral walls connected to each other to form a periphery, wherein each of the lateral wall comprises an upper edge and a first through hole formed near the upper edge;
a tubular body having one end inserted into one of the first through holes and the other end inerted into another first box adjacent to the first box to communicate the first boxes;
a supporting member disposed within the first box, wherein the supporting member has a height identical to the first box to resist a pressure exerting downwards;
a second box stacked on the first box and comprising a second bottom and a plurality of second through holes formed on the second bottom;
a plurality of liquid absorbing strips extending into the first box through the second through holes, wherein each of the liquid absorbing strips comprising a positioning knot formed at one end of the liquid absorbing strip, wherein the liquid absorbing strips hangs from the second bottom of the second box down to the first box due to a size of the positioning knot is larger than a dimension of the second through hole, and the liquid absorbing strips absorb the liquid stored in the first box and transfer the liquid to the second box through capillary effect.

2. The liquid-storing planting device as claimed in claim 1, wherein the first box and the second box are rectangular and have identical dimensions.

3. The liquid-storing planting device as claimed in claim 1, wherein the first box further comprises a first bottom connected to the lateral walls and four spacers, four corners are formed by the first bottom and the lateral walls, each of the corners is provided with one of the spacers, and the spacers extend downwards from the corners to separate the first box from a surface where the first box is placed on the surface so as to allow air flowing therethrough.

4. The liquid-storing planting device as claimed in claim 3, wherein the spacers are integrally formed with the first box.

5. The liquid-storing planting device as claimed in claim 1, wherein the tubular body is a hose.

6. The liquid-storing planting device as claimed in claim 1, wherein the first box further comprises an outer chamfer formed on a top portion of the periphery, and the second box further comprises an inner chamfer formed on the second bottom, and the outer chamfer engages the inner chamfer when the second box is stacked on the first box so that the second box is position to the first box.

7. The liquid-storing planting device as claimed in claim 1, wherein the supporting member is a hollow cylinder or a hollow rectangular body.

8. The liquid-storing planting device as claimed in claim 1, wherein the supporting member is made of Styrofoam.

9. The liquid-storing planting device as claimed in claim 1 further comprising a connecting pipe inserted into one of the first through holes to allow liquid from a liquid source supplied to the first box.

10. The liquid-storing planting device as claimed in claim 1 further comprising a conduit inserted into one of the first through holes to allow liquid from a liquid source supplied to the first box.
